(19) United States
(12) Patent Application Publication
(10) Pub. No.: US 2006/0159896 A1
(43) Pub. Date: Jul. 20, 2006

(54) Laser sintering method with increased process precision, and particles used for the same

(76) Inventors: Rolf Pfeifer, Sindelfingen (DE); Jialin Shen, Bernstadt (DE)

Correspondence Address: AKERMAN SENTERFITT, P.O. BOX 3188, WEST PALM BEACH, FL, 33402-3188, US

(21) Appl. No.: 10/518,699

(22) PCT Filed: Jun. 16, 2003
(86) PCT No.: PCT/DE03/02011

§ 371 Date: Jan. 6, 2006

(30) Foreign Application Priority Data
Jun. 18, 2002 (DE) 202 20 325.5
Mar. 26, 2003 (DE) 103 13 452.2

(51) Int. Cl. B29C 65/00; B32B 37/00

(52) U.S. Cl. 428/206; 428/403; 156/272.8

(57) ABSTRACT

In the rapid prototyping method of selective laser sintering, temperature gradients occur inside and between individual layers, leading to component deformation which is intolerable at least for high-quality components. The air of the invention is to provide a method for selective laser sintering, whereby the temperature inside the built-up particle cake is as homogeneous as possible. To this end, particles containing at least one material having a maximum softening temperature of approximately 70° C. are used.

### BACKGROUND OF THE INVENTION

1. Field of the Invention

The invention relates to a selective laser sintering process in accordance with the preamble of patent claim 7 and to particles for use in this process in accordance with the preamble of patent claim 1. Processes and particles of this type are already known from DE 690 31 061 T2.

2. Related Art of the Invention

Selective laser sintering (SLS) is a rapid prototyping process in which a platform which can be lowered into a building space (building base) bears a layer of particles which is heated in selected regions by a laser beam, so that the particles fuse to form a first layer. Then, the platform is lowered by approximately 20 to 300 μm (depending on the size and type of particles) into the building space and a new layer of particles is applied. The laser beam retraces its path and fuses together the particles of the second layer and also fuses the second layer to the first layer. In this way, a multilayer particle cake is gradually formed, and within this a component, for example an injection mold, is formed.

Within the building space, certain regions—depending on the geometry of the component to be produced—are heated for a longer or shorter period of time by the laser beam, whereas other regions are not heated at all. Moreover, only in each case the top particle layer is heated by the laser, whereas the lower layers release the heat which they absorb to the area surrounding them and cool down. This leads to inhomogeneous temperature distributions and thermal stresses within the particle cake, which can lead to component distortion.

It has already been proposed in DE 690 31 061 T2 that the particle layers be preheated, so that the energy beam only has to introduce a small quantity of energy to join the particles. This measure simultaneously means that the temperature differences between irradiated and unirradiated parts of a layer are reduced, although this is not revealed by DE 690 31 06 T2.

However, temperature gradients continue to occur within and between the individual layers, with in particular those within the layers leading to component distortion which cannot be tolerated at least for high-quality components.

Therefore, DE 101 08 612 A1 proposes, as corrective measure, that the three-dimensional temperature gradient which is customary be forcibly replaced, by means of segmented building-space shell heating, with an approximately one-dimensional temperature gradient (in the direction of the building-space base).

### SUMMARY OF THE INVENTION

The invention is based on the object of providing a further process and particles for selective laser sintering in which the temperature within the bulk-material particle cake is as homogeneous as possible.

This object is achieved by the absolute temperature difference between the irradiated regions and their finishing temperature, i.e. room temperature, being lowered through the use of suitable materials. Suitable materials are those which have a softening point of lower than approximately 70° C. In this context, the term softening point is not to be understood in any narrow sense, but rather it will be clear to the person skilled in the art that it is to be understood as encompassing a temperature at which the particles bond to adjacent particles. This may require partial melting, but in the case of polymers, for example, softening (below the glass transition temperature) may suffice, or it is also conceivable to exceed the activation energy for chemical bonding.

With regard to the particles to be used and the method to be provided, the invention is represented by the features of patent claims 1 and 7. The further claims give advantageous configurations and refinements.

With regard to the particles that are to be provided, the object is achieved, according to the invention, by the fact that they are suitable for use in selective laser sintering (SLS) (i.e. their diameter is less than approximately 300 μm) and they include

a core formed from at least one first material,

an at least partial coating of the core with a second material, (further components are optional)

the second material having a lower softening point than the first material,

and the softening point of the second material is lower than approximately 70° C.

Suitable second materials may be alloys with a low softening point which are used, for example, in fuses (cf. for example JP2001143588A), and moreover saturated linear carboxylic acids with a chain length of ≧16 (e.g. heptadecanoic acid, melting point 60-63° C.) or polymers in the broadest sense (cf. definition and examples below) may also be suitable.

The softening point of the second material of approximately 70° C. or below allows the laser sintering to be carried out at significantly lower temperatures compared to particles which have been used hitherto, and therefore also allows a significantly lower temperature difference between irradiated particles and standard room temperature, of the order of magnitude of 20° C. Tests have shown that the lower maximum temperature difference also improves the temperature homogeneity of the building space as a whole.

Materials with significantly higher softening points entail greater temperature inhomogeneities and therefore reduced component accuracy which is no longer sufficient for precision applications. Materials with significantly lower softening points can only be stored for prolonged periods of time with relative difficulty, since it is necessary to ensure that they do not unintentionally become joined to one another. However, in summer temperatures of over 30° C. in the shade and of over 50° C. under direct sunlight can be reached even in Germany, and therefore unintentional material softening and joining could occur. Consequently, it is advantageous to use second materials with softening points of >30° C., preferably >50° C.

As a further advantage, the use of particles according to the invention allows a significantly greater process rate to be achieved. The standard SLS apparatuses can still be used (cf. for example DE 102 31 136 A1), but the lower softening points means that only a significantly reduced amount of energy needs to be introduced for sintering. For same laser power, this can be achieved with a higher displacement velocity of the laser scanner and therefore a higher process rate. Moreover, the sintered component cools down to room temperature significantly more quickly.

The coating can also be produced using the standard coating processes for powder particles. It is preferable for the coating to be applied in a fluidized-bed reactor or a spray dryer.

In the fluidized-bed reactor, the cores are fluidized and the second material is supplied by spraying in or atomizing a solution (in a suitable solvent), suspension or dispersion. However, it is also possible for the second material to be metered in as a solid in the same way as the powder material and agglomerated with the cores.

Depending on the residence time of the particle material in the coating apparatus, the particles (of a single first material or a material mixture) can be coated individually or built up to form granules by using the second material as a binder phase. The layer thickness of the coating applied can be set, for example, by means of the concentration of the second material in the solution/suspension/dispersion which is sprayed in, the residence time and the temperature in the reactor or spray dryer. Preferred layer thicknesses are between 0.1 and 10 per cent of the mean particle radii.

In an advantageous embodiment of the particle according to the invention, the coating contains a polymer, preferably a thermoplastic polymer. In this context, the term polymer is once again to be interpreted in a broad sense. It is not restricted only to typical plastics, but rather also encompasses polyolefins (waxes), polyacids and bases, organometal polymers, polymer blends and polymers within the broadest sense whose softening points are no higher than 70° C. It is advantageous if they are in the solid state at room temperature. The group defined in this way is sufficiently large to allow coatings which have been chemically and/or physically matched to any desired core materials to be selected. By way of example, the polarity can be selected in a targeted way, or alternatively so can the steric polymer structure. However, for specific requirements the coating may include further components, e.g. surfactants for improving the flow properties, adhesion promoters with respect to the core, micro-sintering particles for a second sintering step and other constituents.

In a particularly advantageous embodiment of the particle according to the invention, the coating contains a polyvinyl acetal, preferably a polyvinylbutyral (PVB). On the one hand, the softening point can be selected in a targeted manner on the basis of the degree of acetalization (there is a range of unsuitable polyvinyl acetals and butyrals with softening points of over 100° C. but also a large number which are suitable with softening points of below 70° C.). On the other hand, polyvinyl acetals are insoluble in most organic solvents, and therefore a component which is joined in this way is fundamentally very durable. Yet it is suitable for precision casting, in particular of cores, since it can be burnt out virtually without leaving any residual ash. In general, it is advantageous for precision-casting use of the SLS components if the coating at least leaves little residual ash.

Further suitable coating materials are to be found in suitable databases, such as BEILSTEIN or GMELIN: for example, poly(alkylen-di- or -tri-sulfides), e.g. poly(methylene trisulfides) with softening points between 55 and 70° C., poly(ethylene glycols), in particular poly(ethylene glycol)amines or -amides with softening points between 50 and 65° C., or copolymers of ethylene and linear alkene(di,tri)ols with a chain length of ≧8 (e.g. poly(ethylene-co-10-undecen-1-ol), melting point approx. 66° C.) are suitable.

In a further advantageous embodiment of the particle according to the invention, the coating is not hygroscopic, and is preferably hydrophobic. This ensures that the particles take up little if any water and can therefore be stored for prolonged periods of time without unintentionally forming aggregates.

In an advantageous embodiment of the particle according to the invention, the core contains at least one element from the group of materials consisting of metal, ceramic, polymer. In this context, these terms are once again to be understood within a broad sense. Metal also encompasses metalloids, ceramic also encompasses sand and the like, and polymer is in accordance with the definition given above. Particles having cores of this type and coatings as described above allow the SLS production of components with virtually any desired physical, in particular mechanical properties.

In particular particles with a polymethacrylate core, preferably polymethyl methacrylate (PMMA) core, and a polyvinyl acetal, preferably polyvinyl butyral coating are advantageous for precision-casting applications, since particles of this type can be burnt out virtually without leaving any residual ash.

It is also advantageous if the core includes at least two parts selected from the group of materials consisting of metal, ceramic or polymer, loosely or securely joined. These may be at least two parts of the same group element or of different group elements. The parts may be loosely joined (agglomerated) or securely joined (coating/alloy/chemical compound, etc.). This further increases the range of options with regard to physical properties of the SLS component to be produced.

With regard to the SLS process which is to be provided, the object is achieved, according to the invention, by the fact that it includes the following steps:

application of a layer of particles to a target surface,

irradiation of a selected part of the layer, corresponding to a cross section of the object, using an energy beam, so that the particles are joined in the selected part,

repetition of the application and irradiation steps for a plurality of layers, so that the joined parts of the adjacent layers combine to form the object,

in which process

particles which contain at least one material whose softening point is lower than approximately 70° C. are used.

This results in the abovementioned advantages with regard to the homogeneity of the temperature gradients and the resulting component quality, as well as the process rate. These advantages arise not only with particles according to the invention but also with particles which consist of only a single material or are of a homogeneous composition, provided that they only contain at least one material whose softening point is lower than approximately 70° C.

With particles according to the invention, it is advantageous, in particular with a view to component accuracy, if the radiation energy introduced is such that it leads only to softening of the coating, with resultant joining of the irradiated particles, without melting the core material.

It is also advantageous if at least the particle layer which is to be irradiated in each case is additionally heated, preferably to a temperature level of approx. 2-3° C. below the lowest softening point of the particle materials used. This further reduces temperature inhomogeneities within a layer and originating therefrom. The laser power to be introduced is also reduced further.

A segmented building-space heating in accordance with DE 101 08 612 A1 can additionally be used for ultra-precision requirements.

Objects produced using joined particles according to the invention and/or in accordance with the process according to the invention have only minimal shrinkage-related deviations in their actual geometry from their predetermined desired geometry.

### BRIEF DESCRIPTION OF THE DRAWINGS

The particle according to the invention and the process according to the invention are explained in more detail below with reference to FIGS. 1 and 2 and on the basis of a plurality of exemplary embodiments.

### DETAILED DESCRIPTION OF THE INVENTION

FIG. 1, not to scale, shows the particles according to the invention in accordance with a first exemplary embodiment. These particles are used in an otherwise standard laser sintering process to produce objects. The particles have a core 1 of a PMMA with a softening point of approximately 124° C. and a coating 2 of a PVB with a softening point of approximately 66° C. The laser beam is guided in such a way (power≈10 watts (even lower for low strength requirements), feed rate≈5 m/s, laser spot diameter≈0.4 mm) that the radiation energy which is introduced leads to softening of the coating 2 and therefore to joining of the irradiated particles without the core material being melted in the process. The particles have a mean diameter of approximately 35 μm, with the coating having a thickness of approximately 0.3 to 0.7 μm.

In a process of this type using these particles, the particles are joined only via the superficially softened coatings only minor temperature inhomogeneities occur, resulting in little shrinkage and therefore a high component accuracy, cf. FIG. 2, in which the joined particles 1′ are illustrated in hatched form. The coatings, which are not to scale and have been thickened to make the illustration clearer, have been superficially softened in the joining regions just enough for the particles to be joined.

The accuracy is increased further if the particle layers are preheated to approximately 60° C., since the temperature inhomogeneities are then reduced still further. The laser power and/or feed rate is adapted accordingly. The preheating is carried out by means of IR irradiation of the surface or, if even higher levels of accuracy are required, by means of the segmented shell heating described in DE 101 08 612 A1.

According to a further exemplary embodiment, 1-component particles of pure PVB with a softening point of approximately 66° C. and a mean diameter of approximately 80 μm are used. Particles with mean diameters of approximately 50-100 μm are likewise suitable. The components formed have a lower mechanical load-bearing capacity and can predominantly be used as models or also as what are known as lost cores, in particular for precision casting applications.

Particles with metallic and/or ceramic cores and preferably likewise metallic coatings are used for applications which have to satisfy higher physical, in particular mechanical demands. Suitable coatings in this case are in particular alloys, especially non-toxic bismuth-lead-indium alloys with a low melting point, which are known to the person skilled in the art as, for example, fuses in accordance with JP2001143588A, or soldering alloys, such as for example the bismuth-lead-tin alloy PAD-165-851 produced by Stan Rubinstein Assoc., Foxboro, Mass. 02035 USA (cf. http://www.sra-solder.com/pastesp.htm).

In the case of metallic particles, the mean diameters are preferably 40-150 μm, or even smaller where particular accuracy is required, and for ceramic particles the mean diameters are generally below 150 μm, preferably 15 to 40 μm, and for particular requirements even as little as 5 μm.

1. A particle for use in selective laser sintering (SLS), including
a core (1) formed from at least one first material,
an at least partial coating (2) of the core (1) with a second material,
the second material having a lower softening point than the first material,
wherein the softening point of the second material is lower than approximately 70° C.

2. The particle as claimed in claim 1, wherein the coating (2) contains a polymer, preferably a thermoplastic polymer.

3. The particle as claimed in claim 2, wherein the coating (2) contains a polyvinyl acetal, preferably a polyvinyl butyral.

4. The particle as claimed in claim 1, wherein the coating (2) is not hygroscopic, and is preferably hydrophobic.

5. The particle as claimed in claim 1, wherein the core (1) contains at least one element selected from the group of materials consisting of metal, ceramic, polymer.

6. The particle as claimed in claim 5, wherein the core 1 includes at least two parts selected from the group of materials consisting of metal, ceramic, and polymer, loosely or securely joined.

7. A process for producing a three-dimensional object by means of SLS, which includes the following steps:
application of a layer of particles to a target surface,
irradiation of a selected part of the layer, corresponding to a cross section of the object, using an energy beam, so that the particles are joined in the selected part,
repetition of the application and irradiation steps for a plurality of layers, so that the joined parts of the adjacent layers combine to form the object,
wherein
particles which contain at least one material whose softening point is lower than approximately 70° C. are used.

8. The process as claimed in claim 7, wherein particles are used comprising
a core (1) formed from at least one first material,
an at least partial coating (2) of the core (1) with a second material,
the second material having a lower softening point than the first material,
wherein the softening point of the second material is lower than approximately 70° C.

9. The process as claimed in claim 7, wherein at least the particle layer which is to be irradiated in each case is additionally heated prior to irradiation with the energy beam, preferably to a temperature level of approx. 2-3° C. below the lowest softening point of the particle materials used.

10. An object formed from joined particles, wherein the particles comprise
a core (1) formed from at least one first material,
an at least partial coating (2) of the core (1) with a second material,
the second material having a lower softening point than the first material,
wherein the softening point of the second material is lower than approximately 70° C.,
and/or wherein the object is formed by a process which includes the following steps:
application of a layer of particles to a target surface,
irradiation of a selected part of the layer, corresponding to a cross section of the object, using an energy beam, so that the particles are joined in the selected part,
repetition of the application and irradiation steps for a plurality of layers, so that the joined parts of the adjacent layers combine to form the object,
wherein
particles which contain at least one material whose softening point is lower than approximately 70° C. are used.

11. The process as claimed in claim 7, wherein coating (2) contains a polymer, preferably a thermoplastic polymer.

12. The process as claimed in claim 11, wherein the coating (2) contains a polyvinyl acetal, preferably a polyvinyl butyral.

13. The process as claimed in claim 7, wherein the coating (2) is not hygroscopic, and is preferably hydrophobic.

14. The process as claimed in claim 7, wherein the core (1) contains at least one element selected from the group of materials consisting of metal, ceramic, polymer.

15. The process as claimed in claim 14, wherein, wherein the core 1 includes at least two parts selected from the group of materials consisting of metal, ceramic, and polymer, loosely or securely joined.
